(19) United States
(12) Patent Application Publication
(10) Pub. No.: US 2026/0278970 A1
(43) Pub. Date: Sep. 17, 2026

(54) POINT CLOUD TRUNCATION

(71) Applicant: Telefonaktiebolaget LM Ericsson (publ), Stockholm (SE)

(72) Inventors: Volodya GRANCHAROV, Stockholm (SE); Sigurdur SVERRISSON, Stockholm (SE); Elljs DIMA, Stockholm (SE); Vladislav POLIANSKII, Stockholm (SE)

(73) Assignee: Telefonaktiebolaget LM Ericsson (publ), Stockholm (SE)

(21) Appl. No.: 19/162,353

(22) PCT Filed: Jun. 16, 2023
(86) PCT No.: PCT/SE2023/050608

§ 371 Date: Sep. 4, 2025

Related U.S. Application Data
(60) Provisional application No. 63/450,229, filed on Mar. 6, 2023.

(51) Int. Cl. G06T 19/20; G06T 7/73; G06T 17/00

(52) U.S. Cl. CPC G06T 19/20; G06T 7/73; G06T 17/00; G06T 2207/10028; G06T 2210/56; G06T 2219/2016

(57) ABSTRACT

A method for processing a point cloud, wherein the point cloud was generated using N images. The method includes, for each of the N images, obtaining two-dimensional, 2D, point information associated with the image, wherein the 2D point information associated with the image identifies a point on a common plane (e.g., the ground plane). The method also includes selecting a point cloud truncation method using the obtained 2D point information. The method also includes implementing the selected a point cloud truncation method on the point cloud (which may result in the creation of a truncated point cloud).

### TECHNICAL FIELD

Disclosed are embodiments related to methods and systems for truncating a point cloud.

### BACKGROUND

An unmanned aerial vehicle (UAV) (a.k.a., “drone”) equipped with one or more sensors (e.g., a red-green-blue (RGB) camera, and RGB depth (RGBD) camera, LiDAR, etc.) can be used to obtain images of an area of interest that contains an object of interest (e.g., a telecommunications cell tower or other OOI) and these images can then be used to generate a three-dimensional (3D) model of the area, including the OOI. For instance, the drone typically orbits the OOI with a camera pointing down at 45° and the camera is used to obtain many images of the OOI from many different angles. These images are then used to form a three-dimensional (3D) point cloud, which is a set of points where each point has a unique location in a 3D space, which location may be defined by 3 values: x, y, z (hence the points that comprise a point cloud are sometimes referred to as 3D points). The most popular approach for generating such a 3D point cloud is to use Structure from Motion (SfM) technology (e.g., SfM technology from Pix4D (www.pix4d.com), COLMAP (see colmap.github.io/), etc.).

The generated 3D point cloud (or just “point cloud” for short) of the OOI is sometimes referred to as a digital twin of the OOI. Digital twins are becoming an essential component in many industrial applications. As noted above, the process of creating the point cloud of a physical environment consists of the steps of data acquisition and 3D reconstruction. Data acquisition is typically performed with visual cameras and/or LiDARs. In the case of modeling of large outdoor structures, like radio towers used in telecommunications or transmission tower used in power grid, etc., the drone orbits the object of interest and collects many high-resolution images at different positions on the orbit. This set of two-dimensional (2D) images are processed for cloud-based 3D Reconstruction that recover 3D geometry and dimensions of the physical environment.

These steps result in a point cloud, which can be used to visually inspect and perform measurement of the 3D scene, or generate CAD/BIM model of the OOI, etc. Out of the millions or hundreds of millions of points within a 3D point cloud, only those points lying on the surface of the OOI, or its very close surroundings, are relevant. That is, for example, points corresponding to a background object (e.g., the ground, the sky, etc.) are negatively affecting user experience and quality of resulting CAD/BIM model. Further, the size of a typical point cloud is of the order of GBs, so a large number unwanted points place a stress on storage and transmission operations. Therefore, point cloud truncation that filters out unnecessary points is an important step in many scenarios.

An alternative to point cloud truncation is to impose controls on the data acquisition step, such as, for example, restricting camera angle, as suggested by a web page hosted at Pix4d.com (see support(dot)pix4d(dot)com/hc/en-us/articles/360041078692-How-to-scan-cell-towers-PIX4Dscan). A problem with this approach is that it works only in special cases (i.e., particular type of scanned object and particular type of orbit). In the general case, the camera always captures unwanted part of the background.

World Intellectual Property (WIPO) published patent applications WO2022/073614 and WO2022/048741 both describe techniques for point cloud truncation with respect to an OOI that consists of a radio tower.

### SUMMARY

Certain challenges presently exist. For instance, the conventional techniques for cloud point truncation work well in specific scenarios (e.g., where the OOI is a specific type of object, such as a tower), but they are not generalized such that they can work well for any type of OOI. Additionally, the conventional techniques make not only make specific assumptions about the OOI, but also have specific requirements on the type of orbit and perform a complete object extraction from the point cloud, which does not allow technicians to inspect, for example, the access road to the tower, etc.

Accordingly, in one aspect there is provided a method for processing a point cloud, wherein the point cloud was generated using N images. The method includes, for each of the N images, obtaining two-dimensional, 2D, point information associated with the image, wherein the 2D point information associated with the image identifies a point on a common plane (e.g., the ground plane). The method also includes selecting a point cloud truncation method using the obtained 2D point information. The method also includes implementing the selected a point cloud truncation method on the point cloud (which may result in the creation of a truncated point cloud).

In another aspect there is provided a computer program comprising instructions which when executed by processing circuitry of a point cloud filtering node (PCFN) causes the PCFN to perform any of the methods disclosed herein. In one embodiment, there is provided a carrier containing the computer program wherein the carrier is one of an electronic signal, an optical signal, a radio signal, and a computer readable storage medium. In another aspect there is provided a PCFN that is configured to perform the methods disclosed herein. The PCFN may include memory and processing circuitry coupled to the memory.

An advantage of the embodiments disclosed herein is that they automatically filter out unwanted points from a 3D point cloud (e.g., points that belong to a remote background), leading to a reduced size filtered 3D point cloud. This reduction in the size of the point cloud makes it easier to visualize/manipulate/measure, easier to handle by BIM/CAD generation modules, cheaper to store, and faster to transmit.

### BRIEF DESCRIPTION OF THE DRAWINGS

The accompanying drawings, which are incorporated herein and form part of the specification, illustrate various embodiments.

FIG. 1 illustrates an example point cloud.

FIG. 2 illustrates a method of obtaining images of an OOI.

FIG. 3 illustrates an example truncated point cloud.

FIG. 4 illustrates Image Reprojection Truncation.

FIG. 5 illustrates a bounding circle.

FIG. 6 illustrates a point cloud filtering node (PCFN) according to some embodiments.

FIG. 7 is a flowchart illustrating a process according to some embodiments.

FIG. 8 is a block diagram of PCFN according to some embodiments.

### DETAILED DESCRIPTION

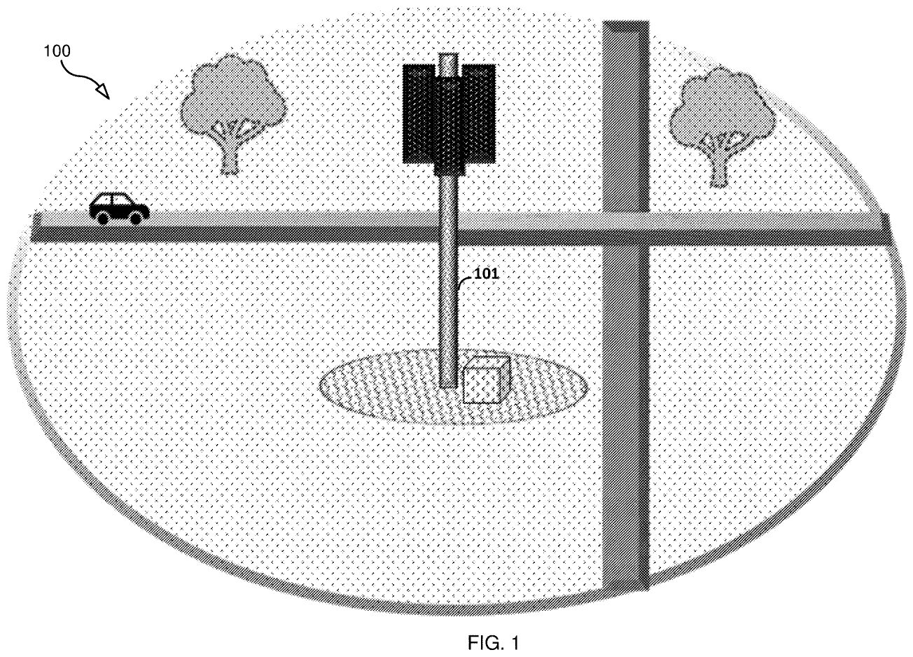

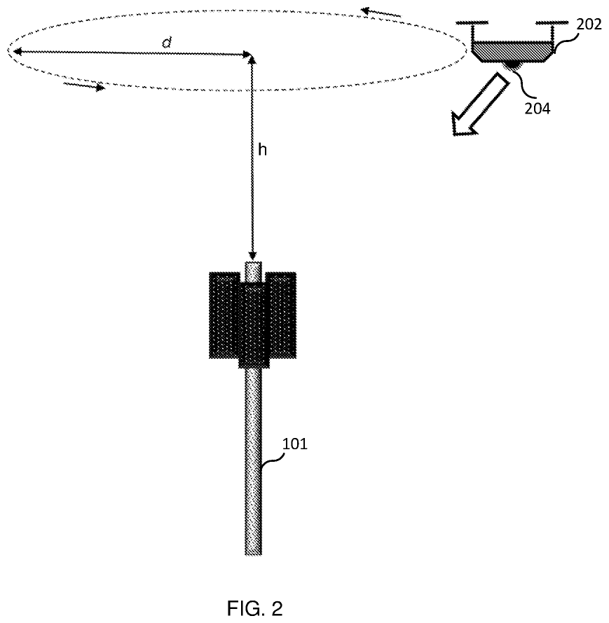

FIG. 1 illustrates an example point cloud 100, may be stored and transferred in popular formats like LAS, PLY, XYZ, etc. The most popular approach for generating point cloud 100 is to use Structure from Motion (SfM) technology (e.g., SfM technology from Pix4D (www.pix4d.com), COLMAP (see colmap.github.io/), etc.). These methods use consecutive images, generated according to the process illustrated in FIG. 2. In this example, the OOI in point cloud 100 is a cell tower 101.

As shown in FIG. 2 images of cell tower 101 are collected using a drone 202 equipped with a camera 204. As shown in FIG. 2, drone 202 orbits cell tower 101, where the orbit has a radius of d (e.g., d is 20 to 40 meters), and at various different points on the orbital path (e.g., 80 to 160 different points on the orbital path) the camera takes an image (thus, generally, 80 to 160 images are obtained). The drone is positioned a distance h from the top of the tower 101 (in some embodiments h=d or h=2d) and the camera 204 points down at 45-60 degrees. Each image taken by the camera 204 captures the entire cell tower 101 from top to bottom. The images are then processed using known techniques to generate point cloud 100.

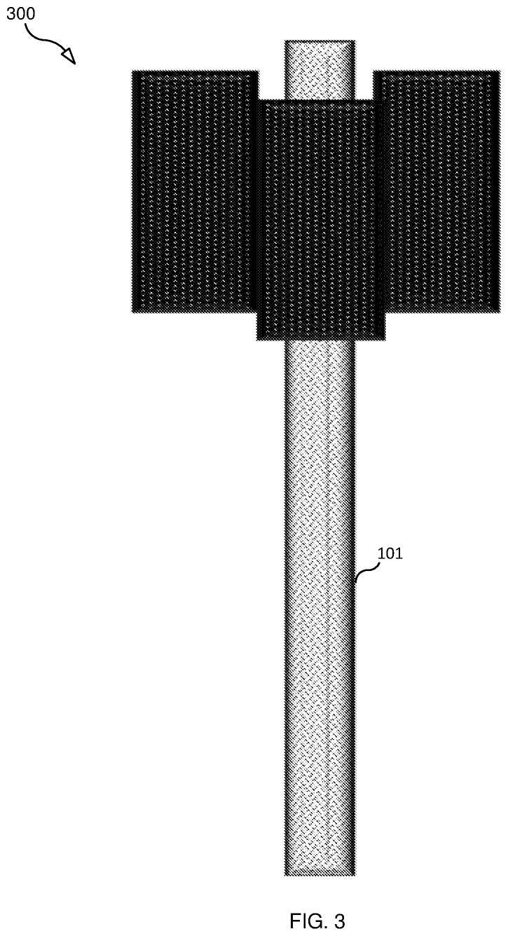

Given that cell tower 101 is the OOI, it can be seen from FIG. 1 that point cloud 100 includes unwanted points (e.g. the points corresponding to the car and/or the points corresponding to the trees). There exists more than one method for truncating (a.k.a., filtering) point cloud 100 to produce a truncated point cloud (see, e.g., the point cloud 300 shown in FIG. 3, which is a truncated version of point cloud 100). To achieve good results, it is important to select the appropriate method.

For example, there exists the following methods: (1) Image Reprojection Truncation; (2) Cylindric Camera Pose Truncation; and (3) No Truncation.

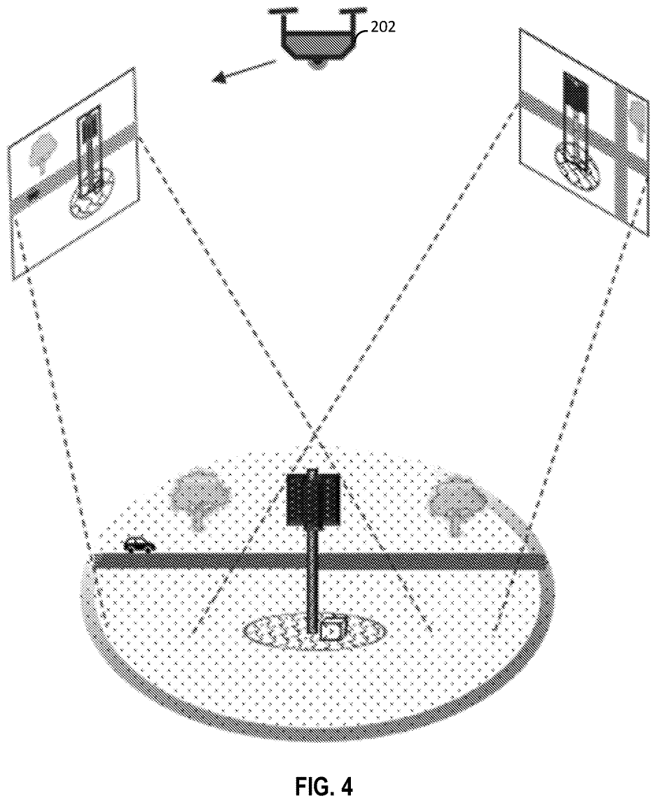

The Image Reprojection Truncation method is based on re-projection of the point cloud in the image boundaries (see FIG. 4). Only the points that are “seen” by all images remain (this is the overlapping area in the center of the image around the radio tower). The points that are visible only from few images are considered to belong to the background.

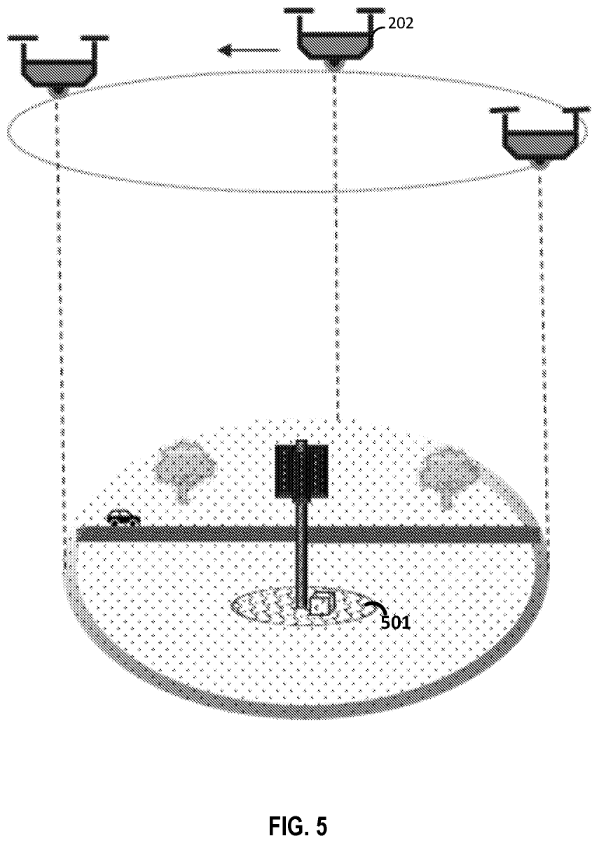

The Cylindric Camera Pose Truncation method keeps the points whose xy-projection falls inside a bounding circle 501 (see FIG. 5). In this case, the drone trajectory determines the volume that contains the object of interest. All points outside of that volume are considered to belong to the background and are discarded.

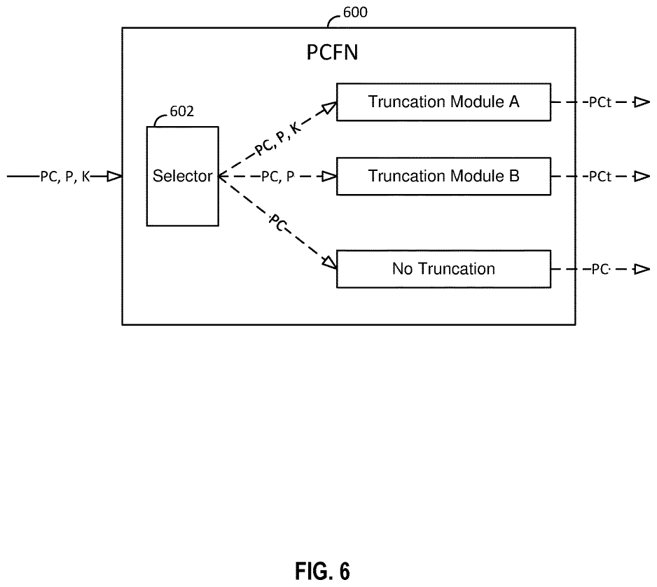

This disclosure provides a point cloud filtering node (PCFN) 600 (see FIG. 6) that is configured to select the appropriate method and then use the selected method to process (or not) the initial point cloud. As shown in FIG. 6, the input to PCFN 600 is: the initial point cloud (e.g., point cloud 100), camera extrinsic parameters (e.g., camera pose information (denoted “P”) indicating camera poses), and intrinsic camera information (denoted “K”) (e.g., the intrinsic camera information comprises focal length information identifying a focal length and/or principal point information identifying a principal point). The “pose” of a camera as used herein is the is position and orientation of the camera in the point cloud coordinate system.

As shown in FIG. 6, PCFN 600 includes a selector 602 that selects truncation module A, truncation module B, or no truncation. In one embodiments, truncation module A implements a projection truncation method, which uses P and K to truncate the point cloud, while truncation module B implements a truncation method based on projection of drone positions on the vertical plane (xy-plane) (e.g. the Cylindric Camera Pose Truncation method).

The selector 602 makes its selection by performing an analysis of camera positions associated with the 2D images that were used to construct the point cloud (PC). The selector 602 allows different truncation modules to be deployed, based on the type of orbit flown by drone 202.

As shown in FIG. 6, the input to selector 602 solution is the generated point cloud (PC) as well as the aligned drone camera positions P in 3D space and intrinsic camera parameters (K). The coordinate system of all data needs to match the real-world scale, e.g., the input point cloud is assumed projected on Universal Transverse Mercator (UTM) coordinate system. The output of PCFN 600 is either a truncated version of the point cloud (PCt) in the same coordinate system or the input point cloud (PC).

Each 2D image used to create the point cloud is associated with a camera position in the 3D space (i.e., the position of the camera when the camera captured the 2D image). In one embodiment, for each 2D image, selector 602 calculates the 2D projection of the camera position associated with the 2D image onto the ground plane (i.e., removing the elevation information (z-axis)). In this way the decision is based on P_{xy} component of the camera positions. In case of N 2D images, there are N two-dimensional points

$${( {P}_{xy} ( n ) )}_{n = 1}^{N} .$$

After obtaining the N two-dimensional points, selector 602 computes the smallest bounding circle that contains all points of P_{xy} using a well-known algorithm (e.g., The miniball method) and calculates the center and radius of that bounding circle (O, Rbnd).

Next, selector 602 determines a circle (O, Rmed) which has the same center as the bounding circle (i.e., O), but different radius (i.e., Rmed≠Rbnd). Rmed is calculated as:

$${R}_{med} = median \{ ( {‖ O - {P}_{xy} ( n ) ‖}_{n = 1}^{N} \} .$$

Next, selector 602 calculates the percentage of the points P_{xy}(n) located on the circle (O, Rmed). A point P_{xy}(n) is said to be on the circle if: |∥O−P_{xy}(n)∥−R_{med}|≤cR_{med}, where c is a parameter that allows small deviation from the “ideal” circle. It has a preferred value of 0.1. Percentage of the points on the circle is denoted as D [%].

Selector 602 is configured such that if D≥90% and Rmed≥T1 (e.g., the T1 may be 15 meters (m)), then selector 602 select truncation module A, else if Rmed<60 m, then selector selects truncation module B, else selector 602 selects no truncation (i.e., Rmed≥60 and non-circular orbits, which is is considered a scan not a modeling of particular object of interest, e.g., areal scan covering large ground areas).

Accordingly, selector 602 may implement the algorithm identified by the pseudo-code in the table below.

```
main ( ){
IF on_circle(P_{xy}, O, R_{med}) AND R_{med} ≥ 15m
      PC_{T} := reprojection_truncation(PC) /* switch to “truncation A” */
ELSE IF R_{bnd} ≤ 60m
      PC_{T} := cylindric_truncation(PC) /* switch to “truncation B” */
ELSE
      PC_{T} := PC /* “NO truncation” */
}
int on_circle (Pxy, O, Rmed){
  if the percentage of points in Pxy that are on the circle defined by O and
Rrmed is greater than a threshold, then
        return 1
    else
        return 0
}
```

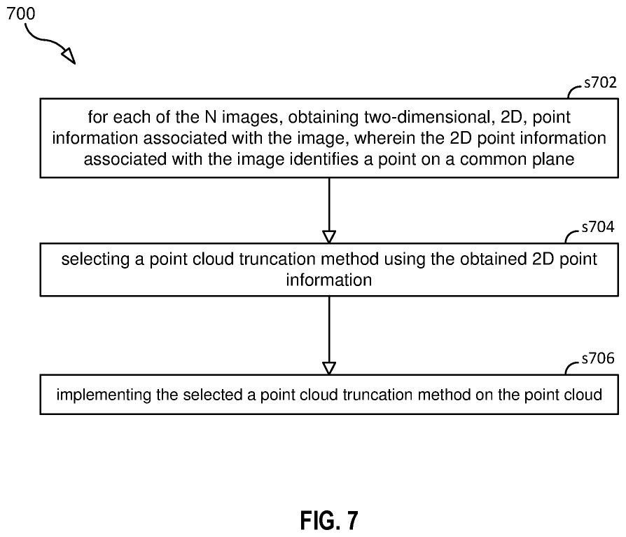

FIG. 7 is a flow chart illustrating a process 700, according to an embodiment, for processing a point cloud, wherein the point cloud was generated using N images. Process 700 may begin in step s 702. Step s702 comprises for each of the N images, obtaining two-dimensional, 2D, point information associated with the image, wherein the 2D point information associated with the image identifies a point on a common plane (e.g., the ground plane). Step s704 comprises selecting a point cloud truncation method using the obtained 2D point information. Because 2D point information is obtained for each of the N images, the obtained 2D point information may identify N two-dimensional points (i.e., one 2D point for each of the N images). For example, the obtained 2D point information may contain N x,y tuples, where each x,y tuple identifies a point on the common plane. Step s706 comprises implementing the selected a point cloud truncation method on the point cloud (which may result in the creation of a truncated point cloud depending on the method selected).

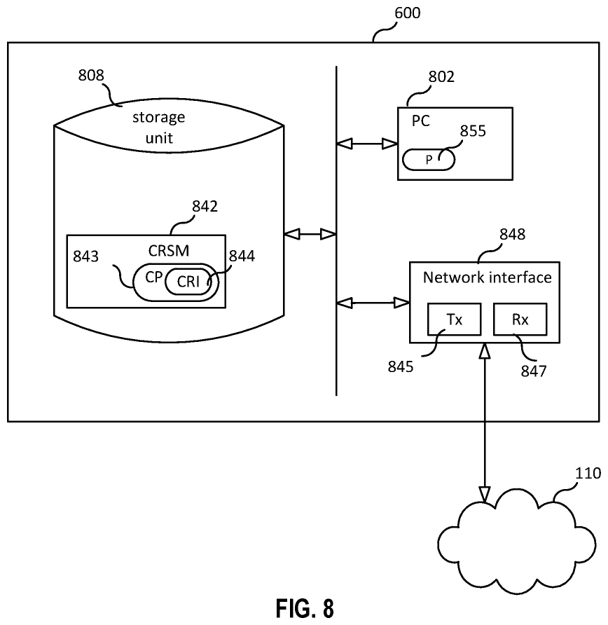

FIG. 8 is a block diagram of PCFN 600, according to some embodiments. As shown in FIG. 8, PCFN 600 may comprise: processing circuitry (PC) 802, which may include one or more processors (P) 855 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., PCFN 600 may be a distributed computing apparatus); at least one network interface 848 (e.g., a physical interface or air interface) comprising a transmitter (Tx) 845 and a receiver (Rx) 847 for enabling PCFN 600 to transmit data to and receive data from other nodes connected to a network 110 (e.g., an Internet Protocol (IP) network) to which network interface 848 is connected (physically or wirelessly) (e.g., network interface 848 may be coupled to an antenna arrangement comprising one or more antennas for enabling PCFN 600 to wirelessly transmit/receive data); and a storage unit (a.k.a., “data storage system”) 808, which may include one or more non-volatile storage devices and/or one or more volatile storage devices. In embodiments where PC 802 includes a programmable processor, a computer readable storage medium (CRSM) 842 may be provided. CRSM 842 may store a computer program (CP) 843 comprising computer readable instructions (CRI) 844. CRSM 842 may be a non-transitory computer readable medium, such as, magnetic media (e.g., a hard disk), optical media, memory devices (e.g., random access memory, flash memory), and the like. In some embodiments, the CRI 844 of computer program 843 is configured such that when executed by PC 802, the CRI causes PCFN 600 to perform steps described herein (e.g., steps described herein with reference to the flow charts). In other embodiments, PCFN 600 may be configured to perform steps described herein without the need for code. That is, for example, PC 802 may consist merely of one or more ASICs. Hence, the features of the embodiments described herein may be implemented in hardware and/or software.

### Summary of Various Embodiments

A1. A method for processing a point cloud, wherein the point cloud was generated using N images, the method comprising: for each of the N images, obtaining two-dimensional, 2D, point information associated with the image, wherein the 2D point information associated with the image identifies a point on a common plane (e.g., the ground plane); selecting a point cloud truncation method using the obtained 2D point information; and implementing the selected a point cloud truncation method on the point cloud.

A2. The method of embodiment A1, wherein obtaining the 2D point information associated with an image comprises: obtaining three-dimensional, 3D, point information associated with the image, wherein the 3D point information associated with the image identifies a location in a 3D space at which a camera was used to obtain the image; and transforming the 3D point information to the 2D point information.

A3. The method of embodiment A2, wherein the 3D point information consists of a longitude value, x, a latitude value, y, and an elevation value, z, and transforming the 3D point information to the 2D point information comprises removing the elevation value.

A4. The method of any one of embodiments A1-A3, wherein the obtained 2D point information identifies N points on the common plane, and selecting a point cloud truncation method using the obtained 2D point information comprises: determining the percentage of the N points that are located on a circle having a center located at O and having a radius of Rmed; and selecting a point cloud truncation method using the determined percentage and Rmed.

A5. The method of embodiment A4, wherein O is the center of the smallest bounding circle that contains all N points.

A6. The method of embodiment A4 or A5, wherein a point p is deemed to be on the circle if |μO−p∥−R_{med}|≤cR_{med}, where c is a predefined factor (e.g. 0.1).

B1. A point cloud filtering node, PCFN, configured to perform the method of any one of embodiments A1-A6.

C1. A computer program (843) comprising instructions (844) which when executed by processing circuitry (802) of a point cloud filtering node, PCFN, causes the PCFN to perform the method of any one of embodiments A1-A6.

C2. A carrier containing the computer program of embodiment C1, wherein the carrier is one of an electronic signal, an optical signal, a radio signal, and a computer readable storage medium (842).

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel. And as used herein “a” means “at least one” or “one or more.”

1. A method for processing a point cloud, wherein the point cloud was generated using N images, the method comprising:
for each of the N images, obtaining two-dimensional (2D) point information associated with the image, wherein the 2D point information associated with the image identifies a point on a common plane;
selecting a point cloud truncation method using the obtained 2D point information; and
implementing the selected a point cloud truncation method on the point cloud.

2. The method of claim 1, wherein obtaining the 2D point information associated with an image comprises:
obtaining three-dimensional (3D) point information associated with the image, wherein the 3D point information associated with the image identifies a location in a 3D space at which a camera was used to obtain the image; and
transforming the 3D point information to the 2D point information.

3. The method of claim 2, wherein
the 3D point information consists of a longitude value, x, a latitude value, y, and an elevation value, z, and
transforming the 3D point information to the 2D point information comprises removing the elevation value.

4. The method of claim 1, wherein
the obtained 2D point information identifies N points on the common plane, and
selecting a point cloud truncation method using the obtained 2D point information comprises:
determining the percentage of the N points that are located on a circle having a center located at a point O and having a radius of Rmed; and
selecting a point cloud truncation method using the determined percentage and Rmed.

5. The method of claim 4, wherein O is the center of the smallest bounding circle that contains all N points.

6. The method of claim 4, wherein a point p is deemed to be on the circle if |∥O−p∥−R_{med}|≤cR_{med}, where c is a predefined factor.

7. A point cloud filtering node (PCFN), the PCFN being configured to perform a method comprising:
for each of the N images, obtaining two-dimensional (2D) point information associated with the image, wherein the 2D point information associated with the image identifies a point on a common plane;
selecting a point cloud truncation method using the obtained 2D point information; and
implementing the selected a point cloud truncation method on the point cloud.

8. The PCFN of claim 7, wherein obtaining the 2D point information associated with an image comprises:
obtaining three-dimensional (3D) point information associated with the image, wherein the 3D point information associated with the image identifies a location in a 3D space at which a camera was used to obtain the image; and
transforming the 3D point information to the 2D point information.

9. The PCFN of claim 8, wherein
the 3D point information consists of a longitude value, x, a latitude value, y, and an elevation value, z, and
transforming the 3D point information to the 2D point information comprises removing the elevation value.

10. The PCFN of claim 7, wherein
the obtained 2D point information identifies N points on the common plane, and
selecting a point cloud truncation method using the obtained 2D point information comprises:
determining the percentage of the N points that are located on a circle having a center located at a point O and having a radius of Rmed; and
selecting a point cloud truncation method using the determined percentage and Rmed.

11. The PCFN of claim 10, wherein O is the center of the smallest bounding circle that contains all N points.

12. The PCFN of claim 10, wherein a point p is deemed to be on the circle if |∥O−p∥−R_{med}|≤cR_{med}, where c is a predefined factor.

13. A non-transitory computer readable storage medium storing a computer program comprising instructions which when executed by processing circuitry of a point cloud filtering node (PCFN) causes the PCFN to perform the method of claim 1.

14. (canceled)
